(19) United States
(12) Patent Application Publication
(10) Pub. No.: US 2007/0087169 A1
(43) Pub. Date: Apr. 19, 2007

(54) Absorbent articles having visually distinct embossments

(75) Inventor: Ronald Ray McFall, Hamilton, OH (US)

Correspondence Address: THE PROCTER & GAMBLE COMPANY;INTELLECTUAL PROPERTY DIVISION, WINTON HILL BUSINESS CENTER - BOX 161, 6110 CENTER HILL AVENUE, CINCINNATI, OH, 45224, US

(73) Assignee: The Procter & Gamble Company

(21) Appl. No.: 11/253,468

(22) Filed: Oct. 19, 2005

(51) Int. Cl. B32B 3/00

(52) U.S. Cl. 428/172; 428/156

(57) ABSTRACT

A fibrous substrate having a first side and a second side, the substrate comprising discrete densified portions on the first side, at least one of the discrete densified portions comprising a colored portion, the colored portion comprising solid residue of a liquid colored substrate applied to fibers of the second side.

### FIELD OF THE INVENTION

The present invention relates to disposable absorbent products, and more particularly to diapers and feminine hygiene articles having visually-perceptible printing thereon.

### BACKGROUND

Absorbent articles, such as diapers and sanitary napkins, are well known in the art. Diapers can include garments intended to be worn by infants, babies and toddlers, as well as by incontinent adult users. Such garments can include training pants and other garments intended to be pulled into place like normal underwear. Sanitary napkins are used by women principally during their menstrual periods to receive and contain menses and other vaginal discharges to protect their garments from soiling. Other articles, such as incontinence pads are similarly worn for control of light urine incontinence. Sanitary napkins and incontinence pads typically have adhesive attachment means to temporarily adhere the device to the crotch region of the user's undergarment, normally her panty.

In an effort to communicate certain benefits, functionality, or simply to appear aesthetically pleasing, manufacturers of disposable absorbent articles have developed various methods of embossing, texturing, printing, and the like. Embossing can impart channels on the body facing side of a sanitary napkin, for example. Embossing can be enhanced by inks or dyes, either around or in the embossing, such as by coating the body facing side of the sanitary napkin with inks or dyes in the region of the embossing. Printing on the backsheet of disposable diapers is well known in the art. Ink jet printing of cartoon graphics, for example, can be utilized for both functional and aesthetic benefits.

One difficulty that all the known methods of imparting embossing and printing seek to overcome is the problem of registering the color of an ink or dye with the embossed portion of the absorbent article. Various methods have been devised, including embossing and coating an ink or dye in a single step, such as by coating an ink on the tips of embossing elements. However, such a process can be difficult to achieve at commercially-acceptable speeds for products such as diapers or sanitary napkins. Further, such a process can be limiting with respect to the variation of color within a pattern of embossments.

Accordingly, there remains an unaddressed need for an improved method for imparting color contrast to disposable absorbent articles.

Further, there remains an unaddressed need for a disposable absorbent article, such as a feminine hygiene article, having relatively small, discrete embossments having color contrast imparted thereto.

Finally, there is an unaddressed need for a feminine hygiene article, or an array of feminine hygiene articles, that can be effectively produced at commercial production speeds for commercial marketing and sale.

### SUMMARY OF THE INVENTION

The present invention is a fibrous substrate having a first side and a second side. The substrate comprises discrete densified portions on the first side, at least one of the discrete densified portions comprising a colored portion. The colored portion comprises solid residue of a liquid colored substrate applied to fibers of the second side.

### BRIEF DESCRIPTION OF THE DRAWINGS

FIG. 1 is a plan view of a feminine hygiene article of the present invention.

FIG. 2 is a cross-sectional view of the portion 2-2 of FIG. 1.

FIG. 3 is a detail of the cross section shown in FIG. 2.

FIG. 4 is a plan view of a feminine hygiene article of the present invention.

FIG. 5 is a plan view of another embodiment of a feminine hygiene article of the present invention.

FIG. 6 is a cross-sectional representation of one embodiment of the present invention.

FIG. 7 cross-sectional representation of one embodiment of the present invention.

FIG. 8 cross-sectional representation of one embodiment of the present invention.

### DETAILED DESCRIPTION OF THE INVENTION

As used herein, the term “absorbent article” refers to devices that absorb and contain liquid, and more specifically, refers to devices that are placed against or in proximity to the body of the wearer to absorb and contain the various exudates discharged from the body. Such articles include disposable diapers, adult incontinence diapers, wipes, mops, feminine hygiene articles, and the like. Although not limited to feminine hygiene articles, the invention will be described herein with respect to feminine hygiene articles. It is understood that the illustrated embodiments are non-limiting examples of the invention, which invention is equally applicable to other embossable fibrous structures, such as topsheets, backsheets, absorbent layers, distribution layers, acquisition layers, and other elements of articles such as diapers, adult incontinence devices, floor cleaning pads, heat-delivering pads, wipes, medical gowns, and the like. The invention can also be utilized in an anal discharge pad, a hemorrhoid pad, an interlabial pad, or any other absorbent article for which embossments having color contrasting portions is desirable.

As used herein, the term “feminine hygiene article” refers to disposable absorbent articles to be worn by women for menstrual and/or light incontinence control. Feminine hygiene articles are typically held in place adjacent the user's externally-visible genitalia (i.e., the pudendal region) by the user's undergarment. Feminine hygiene articles can be placed into the user's undergarment and affixed via adhesive or other joining means. Feminine hygiene articles can also be placed interlabially, wherein the article is held in place between the user's labia, i.e., what are often called interlabial pads. Feminine hygiene articles also include tampons and pessaries.

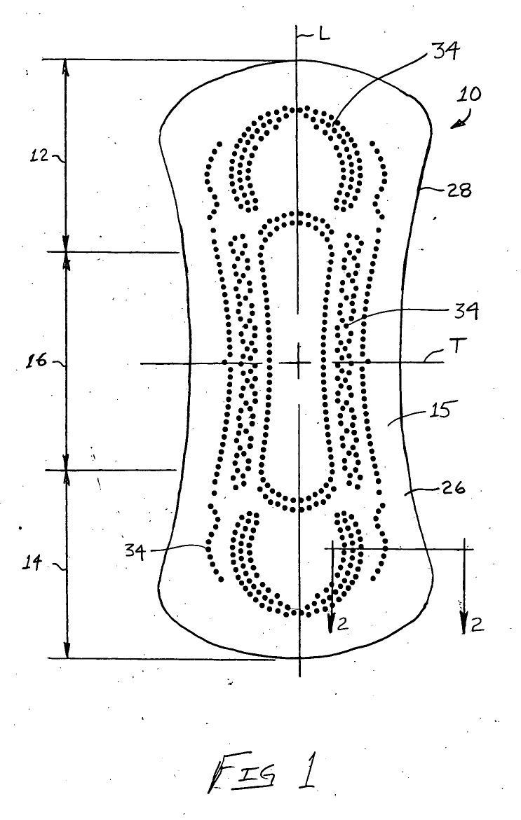

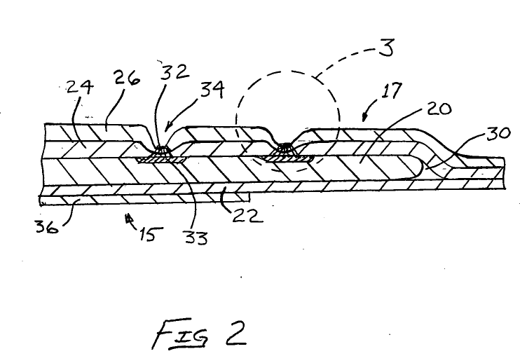

One embodiment of a feminine hygiene article of the present invention, a sanitary napkin 10, is shown in plan view in FIG. 1 and in partial cross section in FIG. 2. While the invention is disclosed in FIG. 1 as an embodiment of a sanitary napkin 10, the disclosed features of the invention can also be useful when incorporated in other feminine hygiene articles, such as incontinence pads and pantiliners. Therefore, the description below is in the context of a sanitary napkin, but it is applicable to feminine hygiene articles in general.

Sanitary napkin 10 can be considered in three regions, two end regions 12 and 14 each comprising about one-third of the overall length, and a middle region 16. Sanitary napkin 10 has a body-facing surface (or side) 15 that is in contact with the user's body during use and a garment-facing surface (or side) 17 that is in contact with the user's undergarment during use. In general, each component layer of the sanitary napkin 10 can be said to have a body-facing side and a garment-facing side, the sides being determined by their orientation relative to the in-use orientation of the article. Sanitary napkin 10 has a longitudinal centerline L and a transverse centerline T, the centerlines being perpendicular to one another in the plane of the sanitary napkin when in a flat out configuration, as shown in FIG. 1. In one embodiment the sanitary napkin can be generally symmetric about both centerlines, while in other embodiments the sanitary napkin can be generally asymmetric about either centerline. In the embodiment shown in FIG. 1, sanitary napkin 10 is symmetric about the longitudinal centerline L and symmetric about transverse centerline T. As discussed more fully below, feminine hygiene articles can also be provided with lateral extensions known in the art as “flaps” or “wings” (not shown in FIG. 1) intended to fold over and cover the panty elastics in the crotch region of the user's undergarment.

Sanitary napkin 10 can have any shape known in the art for feminine hygiene articles, including generally symmetric “hourglass” shaped as shown in FIG. 1, or tapering inwardly from a relatively greater transverse width in a portion of one of the end regions to a relatively smaller transverse width at the middle region, such that the maximum transverse width of one end, e.g., end region 12, of the pad is greater than the maximum transverse width of the other end, e.g., end region 14. Transverse width is defined herein as the edge-to-edge dimension across the article, measured parallel to the transverse centerline T. Such pads can be described as pear shaped, bicycle-seat shaped, trapezoidal shaped, wedge shaped, or otherwise described in a manner that connotes a two-dimensional shape having two ends in which one end is larger than the other in a maximum width dimension.

Sanitary napkin 10 can have an absorbent core 20 to absorb and store bodily fluids discharged during use. In some embodiments of sanitary napkins, pantiliners, incontinence pads, or other such devices of the present invention, an absorbent core is not necessary, the pad consisting only of a topsheet (that can have some absorbency) and a fluid impermeable backsheet. Absorbent core 20 can be formed from any of the materials well known to those of ordinary skill in the art. Examples of such materials include multiple plies of creped cellulose wadding, fluffed cellulose fibers, wood pulp fibers also known as airfelt, textile fibers, a blend of fibers, a mass or batt of fibers, airlaid webs of fibers, a web of polymeric fibers, and a blend of polymeric fibers.

In one embodiment absorbent core 20 can be relatively thin, less than about 5 mm in thickness, or less than about 3 mm, or less than about 1 mm in thickness. Thickness can be determined by measuring the thickness at the midpoint along the longitudinal centerline of the pad by any means known in the art for doing while under a uniform pressure of 0.25 psi. The absorbent core can comprise absorbent gelling materials (AGM), including AGM fibers, as is known in the art.

Absorbent core 20 can be formed or cut to a shape, the outer edges of which define a core periphery 30. The shape of absorbent core 20 can be generally rectangular, circular, oval, elliptical, or the like. Absorbent core 20 can be generally centered with respect to the longitudinal centerline L and transverse centerline T.

To prevent absorbed bodily exudates from contacting the wearer's garments, sanitary napkin 10 can have a liquid impermeable backsheet 22. Backsheet 22 can comprise any of the materials known in the art for backsheets, such as polymer films and film/nonwoven laminates. To provide a degree of softness and vapor permeability for the garment-facing side of sanitary napkin 10, backsheet 22 can be a vapor permeable outer layer on the garment-facing side of the sanitary napkin 20. The backsheet 22 can be formed from any vapor permeable material known in the art. Backsheet 22 can comprise a microporous film, an apertured formed film, or other polymer film that is vapor permeable, or rendered to be vapor permeable, as is known in the art. One suitable material is a soft, smooth, compliant, vapor pervious material, such as a nonwoven web that is hydrophobic or rendered hydrophobic to be substantially liquid impermeable. A nonwoven web provides for softness and conformability for comfort, and can be low noise producing so that movement does not cause unwanted sound.

To provide for softness next to the body, sanitary napkin 10 can have a body-facing layer, referred to herein as topsheet 26. Topsheet 26 can be formed from any soft, smooth, compliant, porous material which is comfortable against human skin and through which fluids such as urine or vaginal discharges can pass. Topsheet 26 can comprise fibrous nonwoven webs and can comprise fibers as are known in the art, including bicomponent and/or shaped fibers. Bicomponent fibers can comprise polypropylene (PP) and polyethylene (PE) in known configurations, including core/sheath, side by side, islands in the sea, or pie. Shaped fibers can be tri-lobal, H-shaped in cross section, or any other known cross-sectional shape. Topsheet 26 can also be a liquid permeable polymer film, such as an apertured film, or an apertured formed film as is known on sanitary napkins such as ALWAYS® brand sanitary napkins.

At least one, and preferably both, of topsheet 26 and backsheet 22 define a shape, the edge of which defines an outer periphery 28 of the sanitary napkin 10. In one embodiment, both topsheet 26 and backsheet 22 define the sanitary napkin 10 outer periphery 28. The two layers can be die cut, as is known in the art, for example, after combining all the components into the structure of the sanitary napkin 10 as described herein. However, the shape of either topsheet 26 or backsheet 22 can be independently defined.

Interposed between the absorbent core 20 and topsheet 26 can be at least one fluid permeable secondary topsheet 24. Secondary topsheet 24 can aid in rapid acquisition and/or distribution of fluid and is preferably in fluid communication with the absorbent core 20. In one embodiment, the secondary topsheet 24 does not completely cover the absorbent core 20, but it can extend laterally to core periphery 30. In one embodiment, topsheet, secondary topsheet, or the absorbent core can be layered structures, the layers facilitating fluid transport by differences in fluid transport properties, such as capillary pressure.

In one embodiment, absorbent core 20 does not extend laterally outward to the same extent as either topsheet 26 or backsheet 22, but the sanitary napkin 10 outer periphery 28 can be substantially larger than the core outer periphery 30. In this manner, the region of sanitary napkin 10 between the core periphery 30 and the sanitary napkin 10 outer periphery 28 can define a breathable zone that permits vapors to go through portions of the sanitary napkin, thereby escaping and providing for dryer comfort when worn. A sanitary napkin having a breathable zone can be according to the teachings of U.S. Ser. No. 10/790,418, filed Mar. 1, 2004.

All the components can be adhered together by means well known in the art with adhesives, including hot melt adhesives, as is known in the art. The adhesive can be Findlay H2128 UN or Savare PM 17 and can be applied using a Dynafiber HTW system.

As is typical for sanitary napkins and the like, the sanitary napkin 10 of the present invention can have panty fastening adhesive 36 disposed on the garment-facing side 17 of backsheet 22. Panty fastening adhesive 36 can be any of known adhesives used in the art for this purpose, and can be covered prior to use by a release paper (not shown), as is well known in the art.

The above disclosure is meant to give a general description of the basic parts of feminine hygiene articles such as sanitary napkins and sanitary napkins and the like as they are known in the art. The description is not intended to be limiting. Any and all of various known elements, features and processes of known sanitary napkins, pantiliners, sanitary napkins, and the like can be incorporated in the feminine hygiene article of the present invention as desired or needed for commercial manufacture, or for particular use benefits. For example, sanitary napkins can be according to the disclosure of U.S. Pat. No. 4,950,264 issued to Osborn III Aug. 21, 1990, and an incontinence pad can be according to the disclosure of U.S. Pat. No. 5,439,458 issued to Noel et al. Aug. 8, 1995. Now, with respect to the remaining disclosure, the novel features and benefits of the present invention will be described.

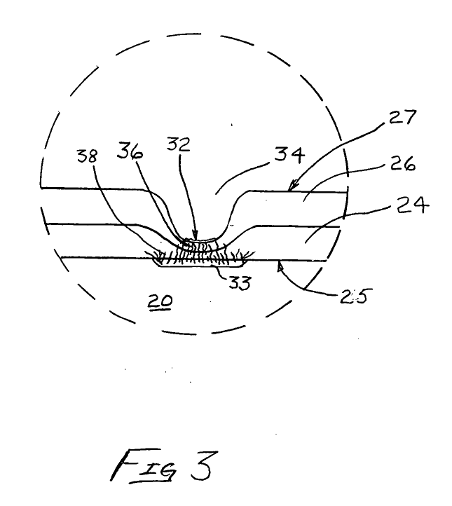

A feminine hygiene article of the present invention comprises one or a plurality of embossed portions 34, the embossed portions 34 having therein a visually-perceptible color contrasting such as colored portion 32 shown in FIGS. 2 and 3. Colored portion 32 can comprise the colored residue of a colored substance 33, which can be applied as a liquid, such as an ink, dye, starch, polyvinyl alcohol, or other substance applied as a liquid to cause a color difference in the colored portion 32. The colored residue can be the solid residue remaining visually perceptible after a liquid portion or other volatiles of an ink, dye, or other like has dried, such as by evaporation.

By “visually perceptible” is meant that a human viewer can visually discern the color of colored substance 33 with the unaided eye (excepting standard corrective lenses adapted to compensate for near-sightedness, farsightedness, or stigmatism, or other corrected vision) in lighting at least equal to the illumination of a standard 100 watt incandescent white light bulb at a distance of 1 meter.

By “colored portion” is meant a portion of an embossed portion which exhibits a visually-perceptible color contrast due to the presence of solid residue resulting from the drying or curing of a color-contrasting ink, dye, stain, paint, or other liquid color means, disclosed herein as a liquid colored substance, which also dries or cures, and is referred to herein as colored substance 33, to distinguish from colored portion 32, which is the portion intended to be viewed as color contrasting by the viewer.

As shown in FIG. 2 and in the detail of FIG. 3, the colored portion 32 is the result of the colored substance 33 having been applied as a liquid and being wicked toward and into the body-facing side of the topsheet 26 from a location on a garment-facing side of the topsheet or an adjacent layer, such as secondary topsheet 24. The colored portions 32 can have very distinct contours, very intense color, and can be precisely limited to be only in embossments 34.

Without being bound by theory, it is believed that the colored portion 32 is achieved by wicking of the liquid colored substance 33 from the area of application on a garment facing side 25 of a fibrous substrate through any intervening layers of fibrous substrates to the body-facing side 27 of topsheet 26. Embossed portion 34 forms localized regions of high density, high capillarity fibers that serve to preferentially wick liquid from regions of lower density and lower capillarity. Therefore, as liquid colored substance 33 is applied to a garment facing side of a fibrous nonwoven secondary topsheet 24 as shown in FIG. 3, it wicks into the fibrous substrate as indicated at 38. However, increased wicking is facilitated in the region adjacent to embossed portion 34 by more-highly densified portions, as indicated at 36. Thus, liquid is preferentially wicked from areas of lower density to areas of higher density which coincide with the lowermost portion of embossed portions 34, as shown in FIG. 3 (with “lowermost” being used to indicate the deepest, lowest portion of the embossment, as shown in FIG. 3).

Depending on the fibrous structures used, such as nonwoven structures typically used for topsheets in disposable absorbent articles, the colored substance can be only visually-perceptible to the extent is wicks through to the other side, e.g., body-facing side 27 of topsheet 26 and may not be visible through the non-embossed portions of the layer or layers. Therefore, colored substance 33 remaining on the side of application, e.g., garment facing side 25 of secondary topsheet 24, can be masked or otherwise unseen from the embossed side, e.g., the body-facing side.

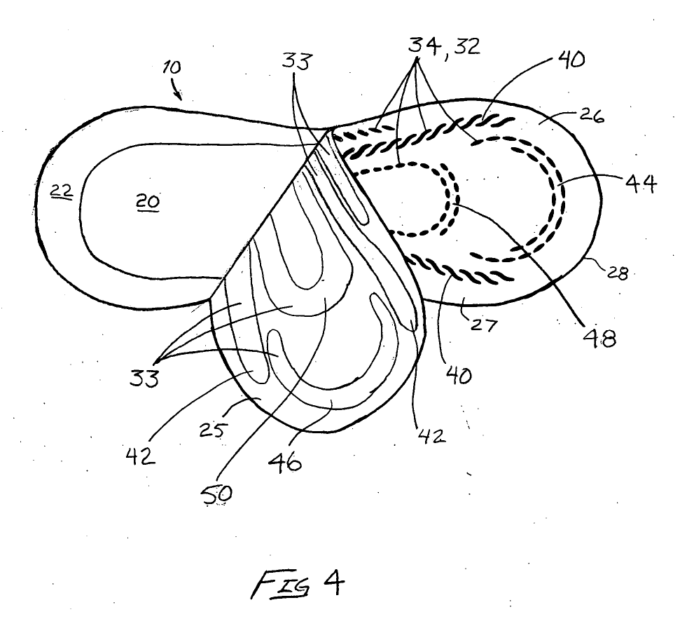

As can be appreciated by the foregoing description, very precise, very intense color can be achieved in very distinct portions of a fibrous structure without having to precisely apply color directly to embossed areas. FIG. 4 shows a sanitary napkin 10 of the present invention with a portion of the topsheet 26 (and optional layers such as secondary topsheet, not shown) peeled back to show the garment facing side thereof. As shown in FIG. 4, embossed portions 34 can be grouped into distinct regions, such as the natural groupings indicated as 40, 44, and 46. To introduce color into body-facing side 27 of the embossed portions 34 of each of the indicated groupings in a very precise manner, colored substance 33 can be applied to the garment facing side 25 in a comparatively imprecise manner.

As shown in FIG. 4, for example, a swath or band of color substrate 33 can be placed on the back side, so to speak, from where the color is desired on the front side, so to speak. For example, if grouping 40 is to be a grouping of red-colored embossed portions 34, then swath or band of color substrate 33 indicated as 42 can be red-colored. Likewise, swath or band of a different color substrate 33 indicated as 46 can be wicked into and cause a different colored portion in grouping 44 and swath or band of still another color substrate 33 indicated as 48 can be wicked into and cause a different colored portion in grouping 50. In general, the number and placement of different colors is limited only by the number of colors available in the preferred form, e.g., ink, dye, paint, and the processing capability of the deposition means to apply the color, e.g., ink jet printing, flexi graphic printing, offset printing, spraying, extruding, or coating, with or without masking.

Swath or band of color substrate 33 can be applied before the embossing step to form embossed portions 34, but such a sequence can have undesirable manufacturing effects. For example, the embossing may need to be performed while the color substrate is liquid, before it dries or cures. Therefore, in another embodiment, swath or band of color substrate 33 can be applied after embossed portions 34 are formed. In one embodiment embossed portions 34 can be formed as part of process of making a finished article such as sanitary napkin 10 shown in FIG. 4. In one embodiment both the embossed portions 34 and the colored portions 32 can be formed as part of a continuous process of making a finished article, such as sanitary napkin 10.

The color intensity or amount of colored portion 32 exposed and visually-perceptible can be varied in at least two ways. By “variation in color intensity” is meant a variation in the intensity of the hue, saturation, color, or a combination of color characteristics. One way is by varying the liquid properties, including quantity, of the colored substance 33. For example, in addition to varying the quantity of liquid deposited, the viscosity, temperature, solids content, and other physical properties can be varied. Additionally, the amount of colored portion 32 exposed and visually-perceptible can by varied by varying the capillary properties of the fibrous material between the area of deposition or application of colored substance 33 and the area of colored portion 32. For example, in the example of a topsheet as shown in FIGS. 1-4, the depth of embossment, and consequently, the amount of fiber compression, can determine the increase in capillarity in the regions denoted as 36 and 38 in FIG. 4. In general, a high degree of densification can result in a greater quantity of liquid transport, and a lower degree of densification can result in a lesser quantity of liquid transport. In this manner, very fine, precise color portions 32 can be (or can comprise) printed indicia, such as letters, word, designs, lines or line segments.

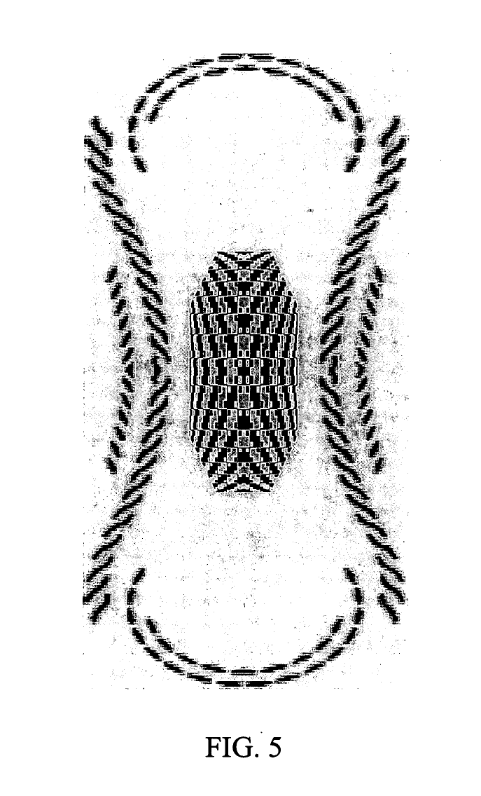

In one embodiment, the capability to, in effect, print very finely distinguishable features by limiting visually-perceptible color to the regions of embossments, also enables other features. For example, as shown in FIG. 5, in one embodiment embossments 34 (shown as the dark areas in FIG. 5) can be placed so as to make an optical illusion when colored with a color-contrasting substance. In the embodiment shown in FIG. 5, the illusion is one of a bulge extending out of the plane of the image. Such an illusion can be beneficial for disposable absorbent products, such as sanitary napkins. The bulge illusion can be placed to coincide with a region of increased absorbency, for example, thereby giving the user a visual cue as to the proper placement of the product. The bulge, created by colored portions 32 in embossed portions 34 can be, for example, a functional enhancement indicator as disclosed in commonly-owned and pending application US 11/012834, entitled Absorbent Article Having a Functional Enhancement Indicator, filed 15 Dec. 2004.

In one embodiment embossed portions 34 are made by running a nonwoven material, or laminate of nonwoven materials, through the nip of a steel patterned roll having raised pattern elements loaded against a smooth steel anvil roll. In general, the amount of densification occurring at embossed portions 34 is dependent upon the gap at the nip between the rolls and the thickness (or basis weight) of the material being embossed. The gap and the resulting densification can be determined and adjusted by means well known in the art of embossing nonwoven webs and laminates of nonwoven webs. In another embodiment embossed portions 34 can be made that also serve as fusion bonds or partial fusion bonds to join two or more nonwoven substrates together.

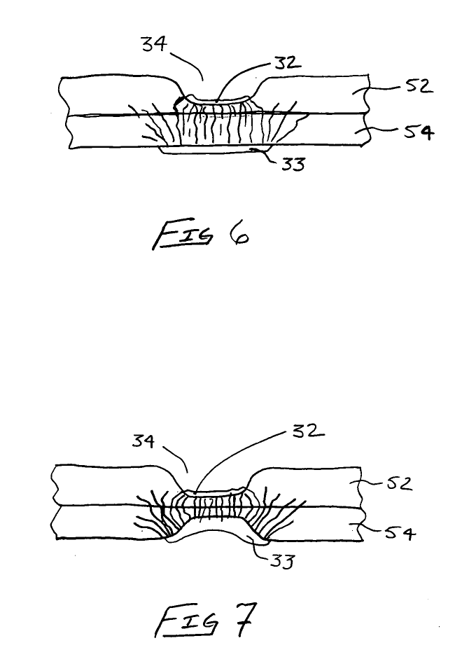

As shown in FIG. 6, two layers, such as upper layer 52 and lower layer 54 can be embossed through a nip comprising one flat roller or platen, such that the embossment densities the laminate only on one side. Colored substance 33 can absorb or wick through lower layer 54 and be absorbed into the densified region of upper layer 52 to make colored portion 32 which is visible in embossed region 34.

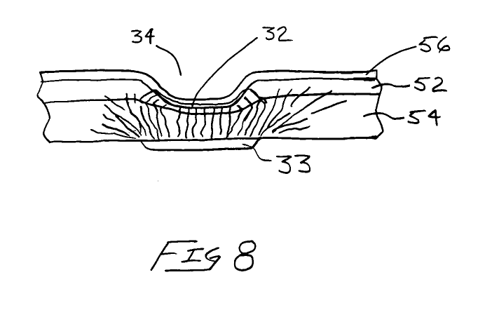

As shown in FIG. 7, two layers, such as upper layer 52 and lower layer 54 can be embossed through a nip comprising mating nubs, such that the embossment densifies the laminate on both sides. Colored substance 33 can absorb or wick through the densified region of both layers, to cause color to shown through the embossed portion of the upper layer 52 which is visible in embossed region 34.

As shown in FIG. 8, additional layers can be added to the laminate without detracting from the utility of the invention. For example, in addition to fibrous layers 52 and 54, a substantially transparent or translucent film layer 56 can be added to the side of the laminate opposite the side of color substance 33 to cause color to show through the embossed portion of the upper layer 52 which is visible through film layer 56 in embossed region 34.

Embossed portions 34 can be made by running a nonwoven material, or laminate of nonwoven materials, through the nip of a steel patterned roll with circumferentially-continuous load bearing members loaded against a smooth steel anvil roll. A suitable process is disclosed, for example, in WO199926769A2 and WO2004108037A1. The purpose of the circumferentially-continuous load bearing members is to balance the patterned roll (that is, to equalize the forces on the patterned roll when the materials to be bonded pass between the patterned roll and the anvil roll). The use of load bearing members is particularly preferred when the pattern on the patterned roll is “unbalanced” or “imbalanced.” By “unbalanced” or “imbalanced”, it is meant that the pattern elements are distributed in a manner in which the pressure in the nip between the patterned roll and the anvil roll varies around the circumference of the patterned roll due to differences in the surface area of the lands of the pattern elements and/or due to the distribution of the pattern elements. By adjusting the load bearing members, the gap at the nip between the raised pattern elements on the patterned roll and the anvil roll can be adjusted. This adjustment, of course, serves to determine the amount of densification of the fibrous material at embossed portions 34. If more densification is desired, the gap can be made smaller, for example.

In addition to the illusion created as shown in FIG. 5, other illusions can be created by printing optical illusion-creating graphics. Optical illusions can enhance the appearance of the article by affecting the viewer's perception of the articles shape, size, color, thickness, or other physical characteristics. In general, printing can be utilized to enhance the 3-D appearance of embossed areas, or even to cause a 2-D portion of an article to appear to have 3-D characteristics.

The present invention can be utilized to more efficiently use printing inks, for example, ink jet printed inks. Ink jet printing is a process that prints, or “jets” closely-spaced, ink droplets, which can be thought of as “pixels” of ink, to make a visually-continuous pattern of color. A visually-continuous pattern is produced when the density of the ink droplets deposited on a substrate is such that the human eye sees a generally uniform continuous pattern of color. By use of the present invention, smaller droplets, or less closely-spaced droplets of ink can be used. By using less closely-spaced droplets, less density of pixels, so to speak, two beneficial results are achieved. First, less ink is deposited on the side of ink deposition, so less unwanted color is apt to show through, if possible, such as when applied to thin fibrous webs. Second, because of wicking and spreading within the densified regions of embossment, such as 34 in FIG. 3, the relatively low-density application of ink droplets is concentrated so as to appear the same as if a higher density of ink had been applied. In one embodiment, an ink droplet expanded to be from 20% to 50% of its deposited size due, it is believed, to capillary action within the densified embossed region. As a result, relatively low resolution ink jet printing can be utilized without a sacrifice in visual appearance in products such as feminine hygiene articles. In one embodiment, a relatively low resolution ink jet printing at 5 dots per square millimeter gave visually-acceptable results equivalent to that of a resolution of about 20 dots per square millimeter, resulting in a reduction in ink usage of about 75%.

All documents cited in the Detailed Description of the Invention are, are, in relevant part, incorporated herein by reference; the citation of any document is not to be construed as an admission that it is prior art with respect to the present invention.

While particular embodiments of the present invention have been illustrated and described, it would be obvious to those skilled in the art that various other changes and modifications can be made without departing from the spirit and scope of the invention. For example, a fibrous substrate could be a paper substrate, such as tissue paper. Embossing of bath tissue and paper towels is well known in the art, and color could be added to the embossments of tissue paper. It is therefore intended to cover in the appended claims all such changes and modifications that are within the scope of this invention.

1. A fibrous substrate having a first side and a second side, the substrate comprising discrete densified portions on the first side, at least one of said discrete densified portions comprising a colored portion, the colored portion comprising solid residue of a liquid colored substrate applied to fibers of the second side, said discrete densified portions comprising a colored portion making an optical illusion.

2. The fibrous substrate of claim 1, wherein said densified portion comprises an embossed portion.

3. The fibrous substrate of claim 1, wherein the colored portion is visually-perceptible from the first side.

4. The fibrous substrate of claim 1, wherein said first and second sides are sides of a single layer nonwoven web.

5. The fibrous substrate of claim 1, wherein said first and second sides are sides of a multilayer nonwoven web laminate.

6. The fibrous substrate of claim 1, wherein said liquid colored substrate is chosen from the group consisting of ink, dye, and paint.

7. The fibrous substrate of claim 1, wherein said liquid colored substrate is applied by ink jet printing.

8. A fibrous substrate having a first side and a second side, the substrate comprising a colored portion, said colored portion making an optical illusion.

9. (canceled)

10. The fibrous substrate of claim 8, wherein the colored portion is visually-perceptible from the first side.

11. The fibrous substrate of claim 8, wherein said first and second sides are sides of a single layer nonwoven web.

12. The fibrous substrate of claim 8, wherein said first and second sides are sides of a multilayer nonwoven web laminate.

13. (canceled)

14. A multilayer nonwoven web having a first side and a second side, the web comprising discrete densified portions on at least the first side, at least one of said discrete densified portions comprising a colored portion, the colored portion comprising solid residue of a liquid colored substrate applied to fibers of the second side, said discrete densified portions comprising a colored portion making an optical illusion.

15. The fibrous substrate of claim 14, wherein said densified portion comprises an embossed portion.

16. The fibrous substrate of claim 14, wherein the colored portion is visually-perceptible from the first side.

17. The fibrous substrate of claim 14, wherein said first and second sides are sides of a single layer nonwoven web.

18. The fibrous substrate of claim 14, wherein said first and second sides are sides of a multilayer nonwoven web laminate.

19. The fibrous substrate of claim 14, wherein said liquid colored substrate is chosen from the group consisting of ink, dye, and paint.

20. The fibrous substrate of claim 19, wherein said liquid colored substrate is applied by ink jet printing.
